(19) United States
(12) Patent Application Publication
(10) Pub. No.: US 2026/0339664 A1
(43) Pub. Date: Oct. 29, 2026

(54) MULTIPLE-OUTER-PRODUCT INSTRUCTION

(71) Applicant: Arm Limited, Cambridge (GB)

(72) Inventors: Arnaud Philippe Claude Grasset, Biot (FR); Jelena Milanovic, Biot (FR)

(73) Assignee: Arm Limited, Cambridge (GB)

(21) Appl. No.: 19/110,750

(22) PCT Filed: Jul. 14, 2023
(86) PCT No.: PCT/GB2023/051858

§ 371 Date: Mar. 11, 2025

(30) Foreign Application Priority Data
Sep. 14, 2022 (GB) 2213475.3

(51) Int. Cl. G06F 9/30; G06F 17/16

(52) U.S. Cl. CPC G06F 9/3001; G06F 9/30036; G06F 9/30109; G06F 17/16

(57) ABSTRACT

A multiple-outer-product instruction specifies multiple first source vector operands, at least one second source vector operand and correlation information associated with the second source vector operand(s), each vector operand comprising multiple data elements and the correlation information indicating, for each data element of a given second source vector operand, a corresponding first source vector operand. In response to the multiple-outer-product instruction, instruction decoder circuitry (50) controls processing circuitry (60) to perform computations to implement outer product operations, the outer product operations comprising, for a given first source vector operand, performing an associated outer product of that first source vector operand with a subset of data elements of the second source vector operand(s). The processing circuitry selects, for each data element of the second source vector operand(s), a corresponding first source vector operand to be used when performing the associated outer product operation, in dependence on the

The present technique relates to the field of data processing.

A data processing apparatus may comprise processing circuitry which is capable of performing outer product operations, in which an outer product of two vectors is calculated. The processing circuitry may further be arranged to perform multiple outer product operations on different pairs of vectors in order to multiply together two matrices.

Outer products and matrix multiplication have a number of applications. For example, execution of an Artificial Neural Network (ANN) typically involves matrix multiplications.

However, multiplication operations can be relatively slow, and each outer product operation (let alone each matrix multiplication) typically involves a large number of multiplication operations (e.g. a multiplication for each pair of data elements in the input vectors). Hence, there can be a significant performance impact associated with performing outer product operations, and it would hence be desirable to provide techniques for more efficiently performing outer product operations, especially in situations where multiple outer product operations are to be performed.

In a first example of the present technique, there is provided an apparatus comprising:
processing circuitry to perform vector operations; and
instruction decoder circuitry to decode instructions from a set of instructions to control the processing circuitry to perform the vector operations specified by the instructions,
wherein:
the set of instructions comprises a multiple-outer-product instruction specifying a plurality of first source vector operands, at least one second source vector operand and correlation information associated with the at least one second source vector operand, wherein each vector operand comprises a plurality of data elements and, for a given second source vector operand, the correlation information is arranged to indicate, for each data element of the given second source vector operand, a corresponding first source vector operand;
the instruction decoder circuitry is responsive to the multiple-outer-product instruction to control the processing circuitry to perform a plurality of computations to implement a plurality of outer product operations, wherein the plurality of outer product operations comprise, for a given first source vector operand, performing an associated outer product operation to calculate an outer product of the given first source vector operand with a subset of data elements of the at least one second source vector operand; and
the processing circuitry is configured to select, for each data element of the at least one second source vector operand, a corresponding first source vector operand to be used when performing the associated outer product operation, in dependence on the correlation information.

In a second example of the present technique, there is provided a method comprising:
performing vector operations using processing circuitry;
decoding instructions from a set of instructions to control the processing circuitry to perform the vector operations specified by the instructions,
wherein:
the set of instructions comprises a multiple-outer-product instruction specifying a plurality of first source vector operands, at least one second source vector operand and correlation information associated with the at least one second source vector operand, wherein each vector operand comprises a plurality of data elements and, for a given second source vector operand, the correlation information is arranged to indicate, for each data element of the given second source vector operand, a corresponding first source vector operand;
the method comprises, in response to the multiple-outer-product instruction performing a plurality of computations to implement a plurality of outer product operations, wherein the plurality of outer product operations comprise, for a given first source vector operand, performing an associated outer product operation to calculate an outer product of the given first source vector operand with a subset of data elements of the at least one second source vector operand; and
selecting, for each data element of the at least one second source vector operand, a corresponding first source vector operand to be used when performing the associated outer product operation, in dependence on the correlation information.

In a third example of the present technique, there is provided a computer program comprising instructions which, when executed on a computer, control the computer to provide:
processing program logic to perform vector operations; and
instruction decoder program logic to decode target instructions from a set of target instructions to control the processing program logic to perform the vector operations specified by the target instructions,
wherein:
the set of target instructions comprises a multiple-outer-product instruction specifying a plurality of first source vector operands, at least one second source vector operand and correlation information associated with the at least one second source vector operand, wherein each vector operand comprises a plurality of data elements and, for a given second source vector operand, the correlation information is arranged to indicate, for each data element of the given second source vector operand, a corresponding first source vector operand;
the instruction decoder program logic is responsive to the multiple-outer-product instruction to control the processing program logic to perform a plurality of computations to implement a plurality of outer product operations, wherein the plurality of outer product operations comprise, for a given first source vector operand, performing an associated outer product operation to calculate an outer product of the given first source vector operand with a subset of data elements of the at least one second source vector operand; and
the processing program logic is configured to select, for each data element of the at least one second source vector operand, a corresponding first source vector operand to be used when performing the associated outer product operation, in dependence on the correlation information. The computer program described above is, in some examples, stored on a computer-readable storage medium. The computer-readable storage medium can be transitory or non-transitory.

Further aspects, features and advantages of the present technique will be apparent from the following description of examples, which is to be read in conjunction with the accompanying drawings, in which:

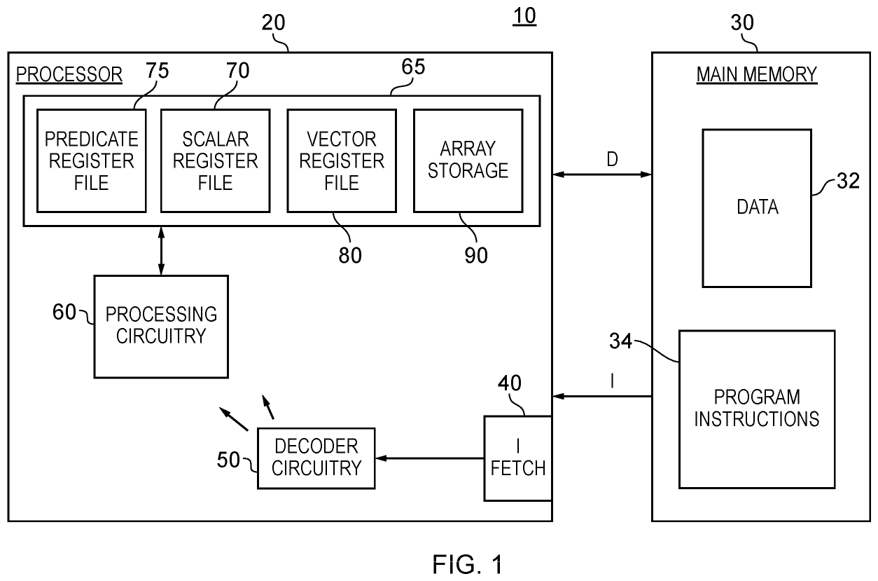

FIG. 1 is a block diagram of a data processing apparatus;

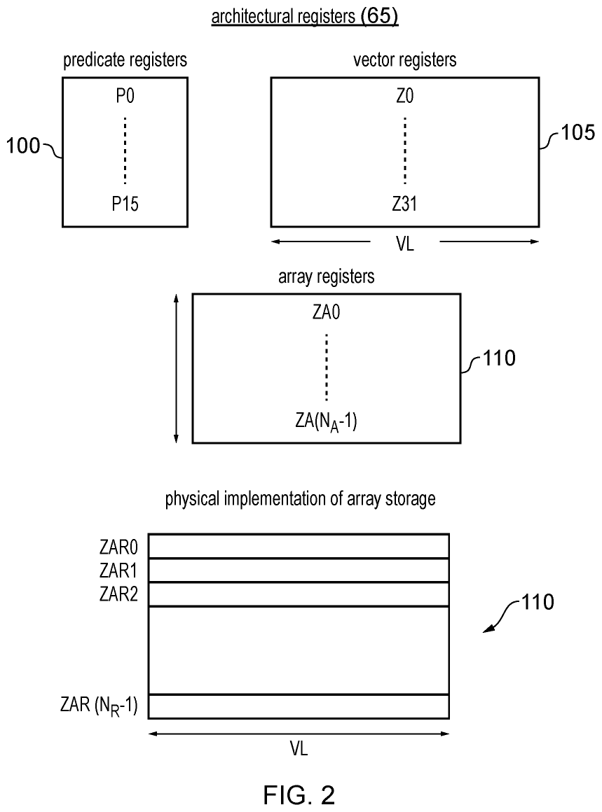

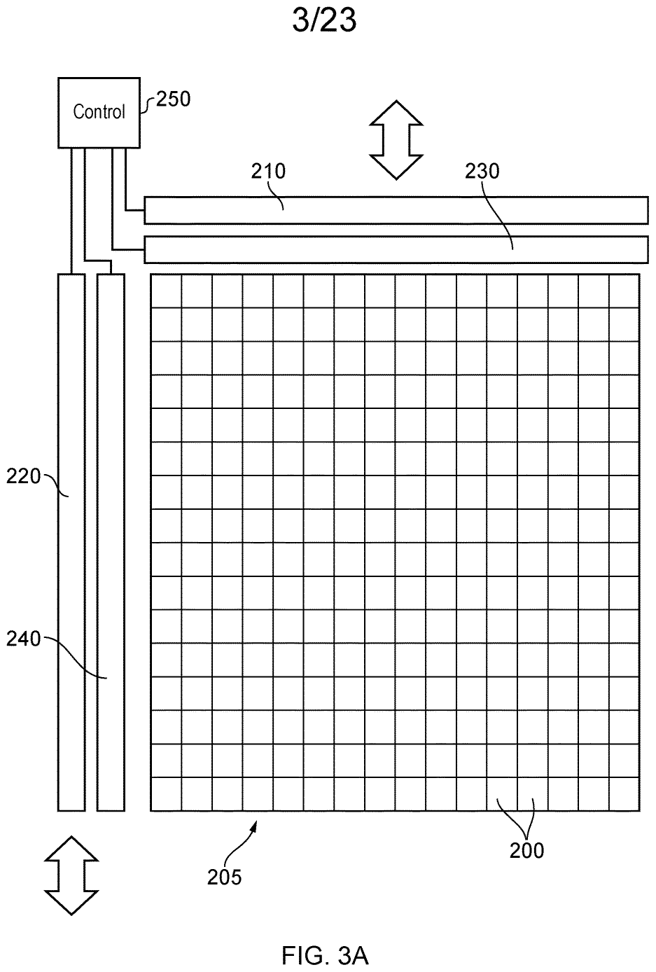

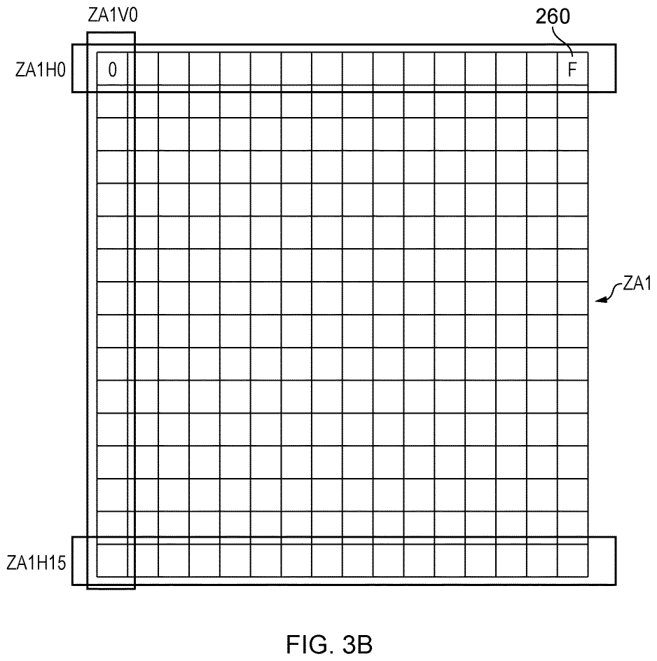

FIG. 2 shows an example of architectural registers that may be provided within the apparatus, including vector registers for storing vector operands and array registers for storing 2D arrays of data elements, including an example of a physical implementation of the array registers;
FIGS. 3A and 3B schematically illustrate how accesses may be performed to a square 2D array within the array storage;

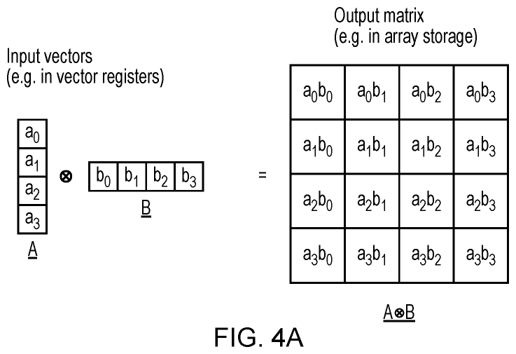

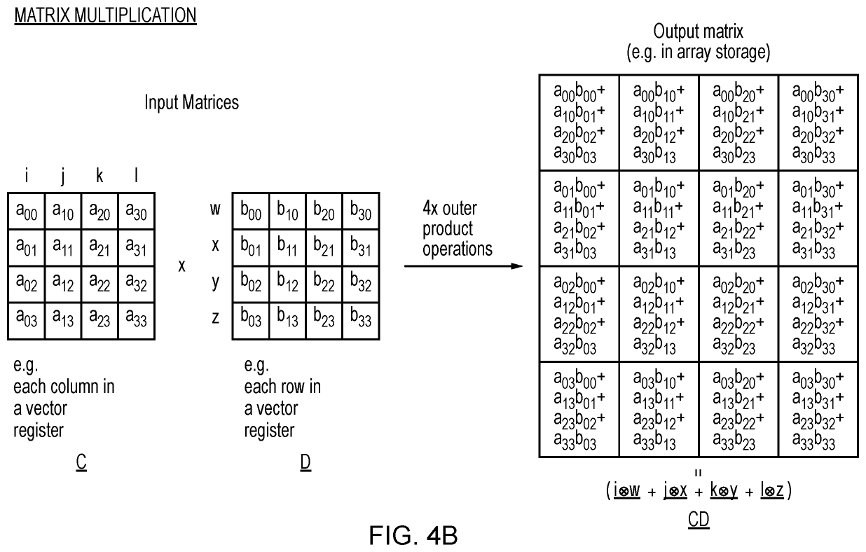

FIG. 4A illustrates an outer product operation;

FIG. 4B illustrates a matrix multiplication operation;

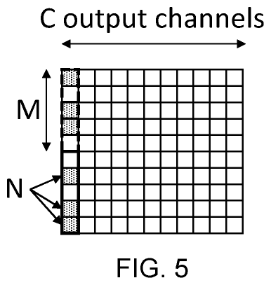

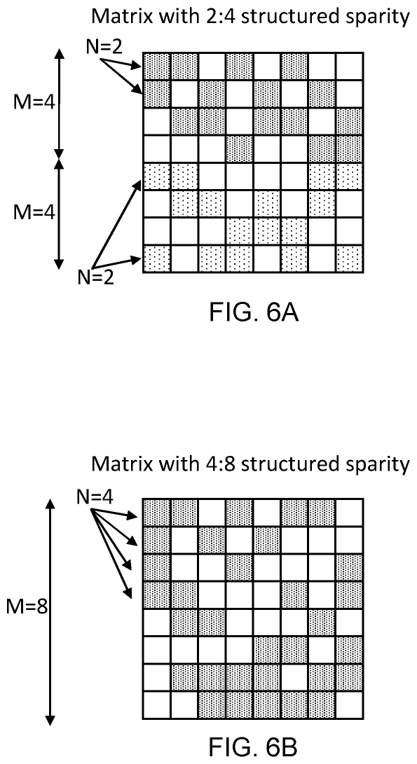

FIGS. 5, 6A and 6B illustrate N:M structured sparsity in matrices;

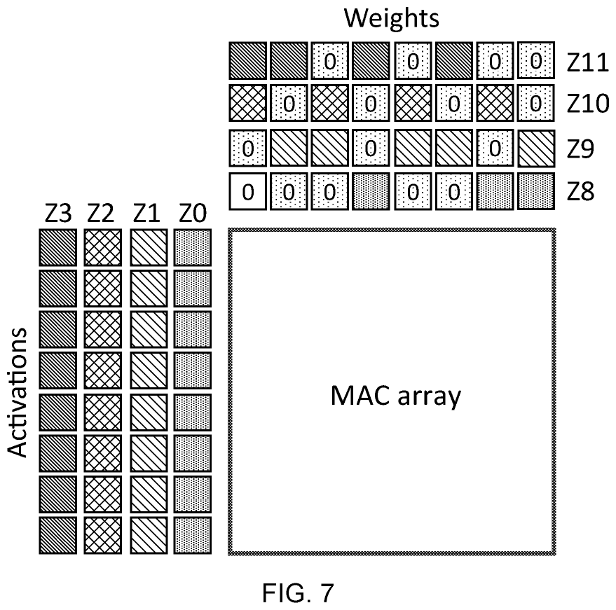

FIG. 7 shows an example of multiplying a matrix of activations by a matrix of weights using a multiply-accumulate (MAC) array;

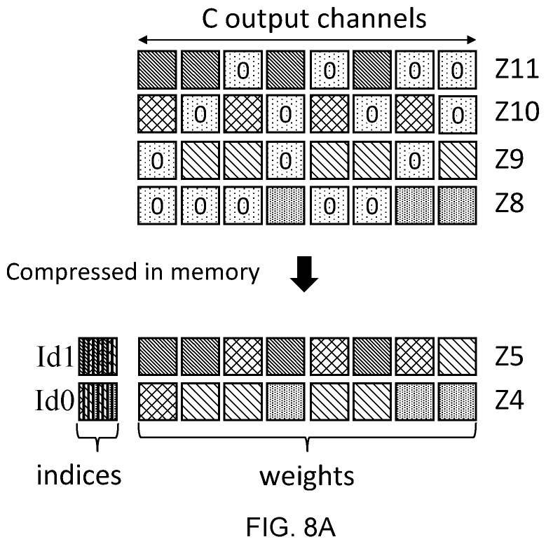

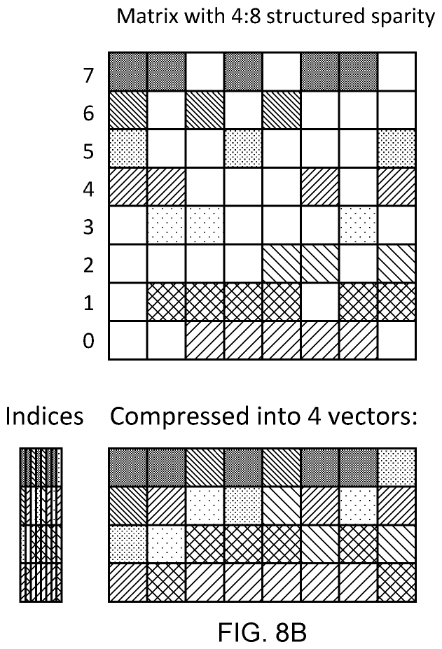

FIGS. 8A and 8B illustrate how matrices with 2:4 and 4:8 structured sparsity can be compressed;

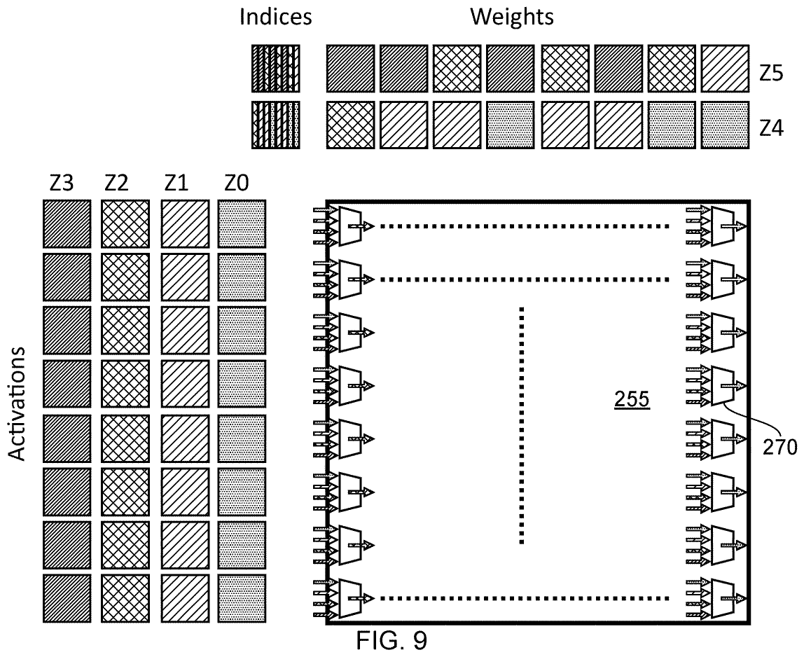

FIG. 9 illustrates a matrix multiplication in which one of the input matrices to be multiplied is a compressed matrix;

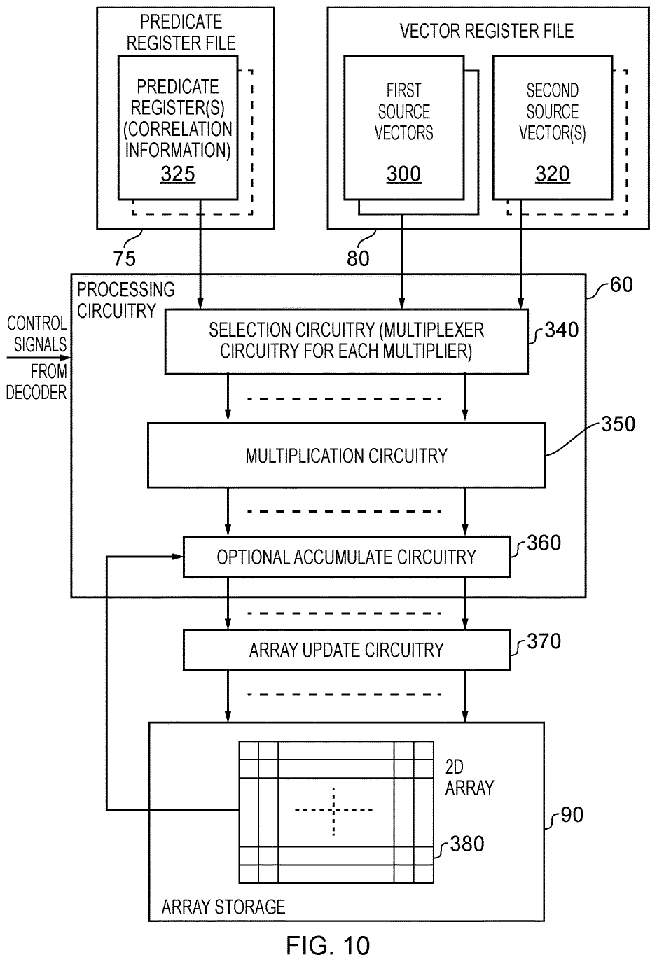

FIG. 10 is a block diagram of a data processing apparatus, illustrating how the processing circuitry is used to perform outer product operations;

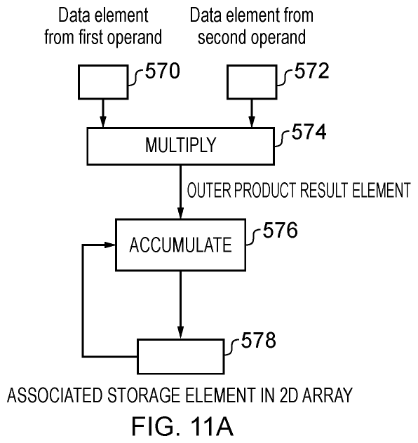

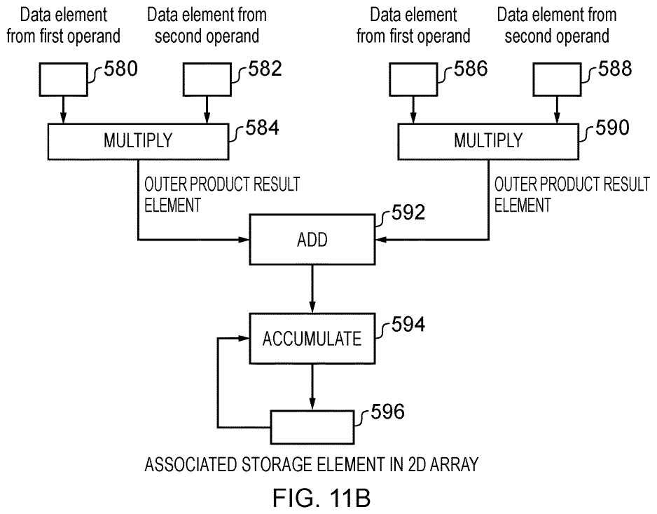

FIGS. 11A and 11B illustrate how generated outer product results can be used to update an associated storage element within a 2D array of the array storage;

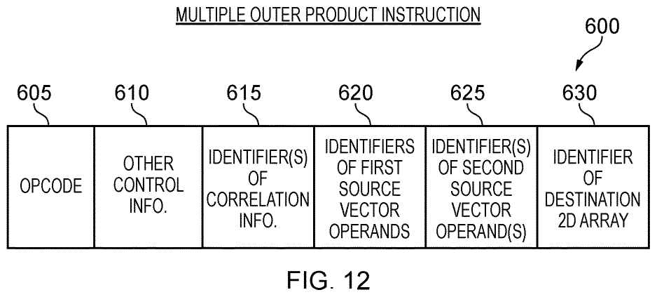

FIG. 12 schematically illustrates fields that may be provided within a multiple outer product instruction;

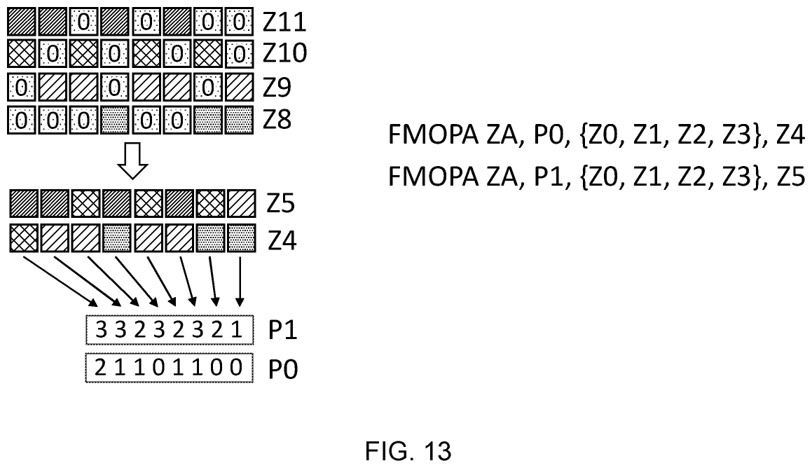

FIGS. 13 to 15 illustrate examples of multiple outer product instructions and examples of how correlation information may be represented;

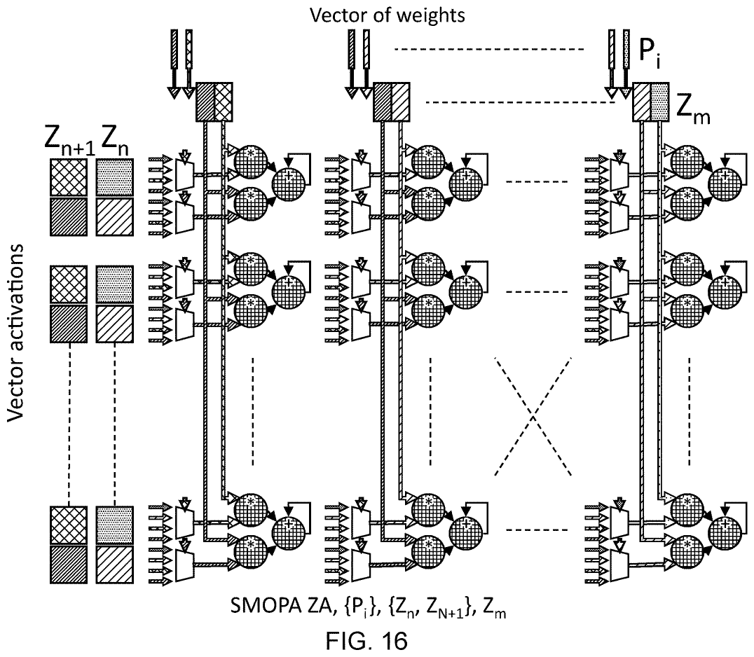

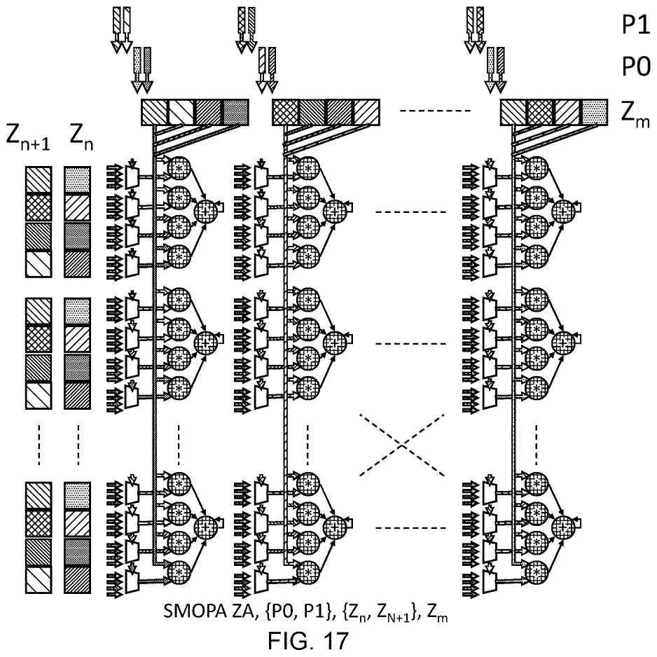

FIGS. 16 and 17 illustrate examples of circuitry for performing a sum of outer products operation;

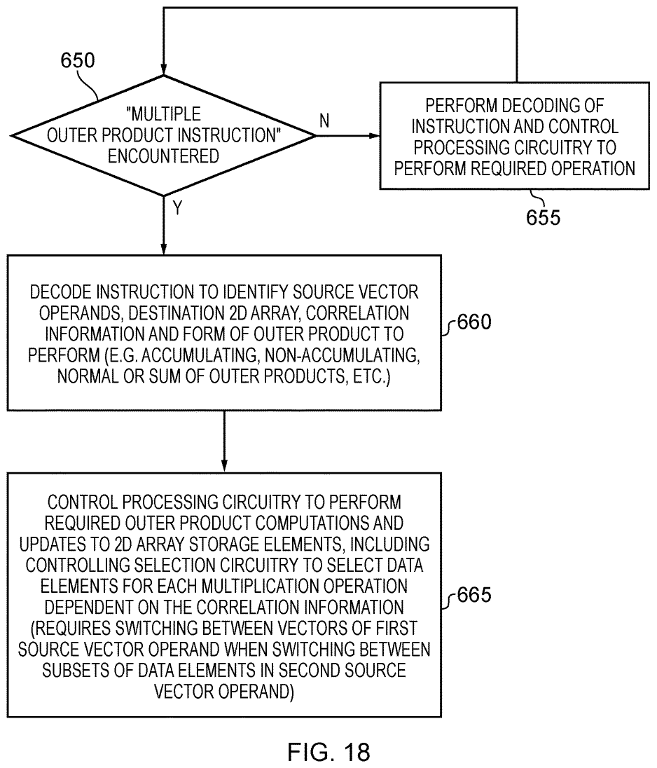

FIG. 18 is a flow diagram illustrating the steps performed upon decoding a multiple outer product instruction; and

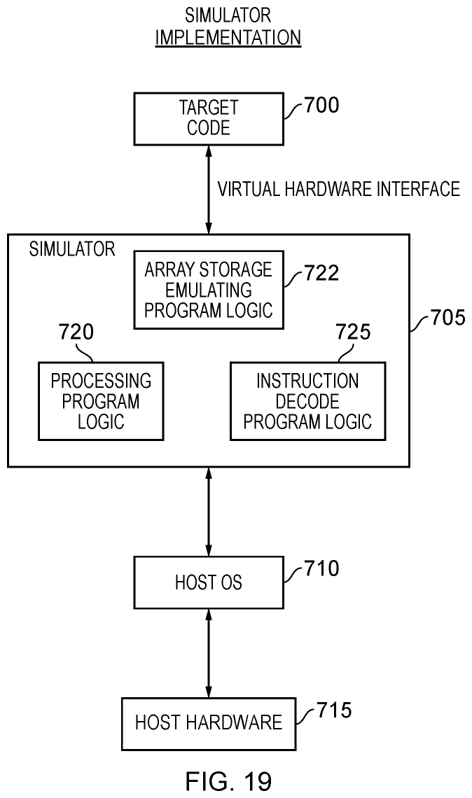

FIG. 19 illustrates a simulator implementation that may be used.

Before discussing example implementations with reference to the accompanying figures, the following description of example implementations and associated advantages is provided.

In accordance with one example configuration there is provided an apparatus comprising processing circuitry and instruction decoder circuitry. The instruction decoder circuitry (also referred to herein as decoder circuitry or an instruction decoder) is arranged to decode instructions from a set of instructions and control the processing circuitry to perform the vector operations specified by the instructions. For example, the instruction decoder circuitry may be responsive to the instructions in the set of instructions to generate control signals, and the control signals may control the processing circuitry to perform vector operations.

Vector operations are operations performed on vector operands—e.g. operands comprising multiple data elements. Vector operations can include any operation that involves at least one vector operand, such as a load or store operation to load/store a vector from/to a storage location (e.g. memory or a cache) or an arithmetic operation (e.g. addition, multiplication) performed on vector operands. In the present technique, the processing circuitry is capable of performing vector operations that include at least outer product operations. For example, vector operands may (but need not necessarily) be stored in vector registers, where a single vector register may store an entire vector operand, or where a single vector operand may be spread between multiple vector registers (and hence a single vector register may store elements from multiple vector operands).

The set of instructions which the instruction decoder circuitry is configured to decode for execution by the processing circuitry include at least a “multiple-outer-product” (MOP) instruction. The MOP instruction is defined in the instruction set architecture (ISA) and identifies (e.g. in respective fields of the instruction, either directly or indirectly, e.g. by identifying a register storing the corresponding data values) at least:
a plurality of (e.g. two or more) first source vector operands;
at least one (e.g. one or more) second source vector operand; and
correlation information associated with the at least one second source vector operand.

It should be noted that the terms “first” and “second” are merely labels, and the first and second source vector operands need not necessarily be the first and second (groups of) operands specified by the instruction respectively. On the contrary, the first and second (groups of) source vector operands could be identified by the MOP instruction in either order.

Each source vector operand (e.g. the second source vector operand(s) and each of the plurality of first source vector operands) comprises a plurality of data elements and, for a given second source vector operand, the correlation information is arranged to indicate (e.g. identify, directly or indirectly) a corresponding first source vector operand for each data element in the given second source vector operand. The correlation information may (optionally) also identify corresponding first source vector operands for data elements in any other second source vector operands identified by the instruction (e.g. if more than one second source vector operand is identified by the MOP instruction). Hence, the correlation information identifies any data elements in the second source vector operand that are associated with individual first source vector operands.

The instruction decoder circuitry is responsive to the MOP instruction to control the processing circuitry to perform a plurality of computations to implement a plurality of outer product operations—e.g. in response to a single MOP instruction being decoded by the instruction decoder circuitry, the processing circuitry is configured to perform computations which generate results equivalent to performing two or more outer product operations. The plurality of outer product operations to be performed by the processing circuitry in response to the decoded MOP instruction comprise an outer product operation for each of at least a subset of the first source vector operands identified by the MOP instruction. More particularly, the processing circuitry performs an associated outer product operation for a given first operand to calculate an outer product of that first source vector operand with a subset (e.g. this could be a proper subset—e.g. some but not all) of the data elements of the at least one second source vector operand. The subset of data elements of the at least one second source vector operand to be used for each outer product operation are identified based on the correlation information—in particular, for each data element of the at least one second source vector operand, a corresponding first source vector operand is selected based on the correlation information, to be used when performing the associated outer product operation. (Note that an outer product operation need not, necessarily, be performed for every one of the first source vector operands, or for every subset of the at least one second source vector operand.)

In this way, by providing correlation information to associate first source vector operands with data elements in the at least one second source vector operand, multiple outer product operations are performed in response to a single instruction, even if only one second source vector operand is specified by the instruction. This contrasts with a typical (e.g. “single”) outer product operation, in which a single outer product operation is performed by multiplying each data element of one source vector by each data element of another source vector.

By defining an instruction (the MOP instruction) that enables multiple outer product operations to be performed in response to a single instance of the instruction, throughput of instructions executed by the processing circuitry can be significantly improved. Accordingly, the MOP instruction of the present technique allows the performance of the processing circuitry to be improved. Indeed, in one example implementation, these multiple outer product operations can be performed in parallel, even further improving throughput.

In addition to increasing throughput, providing correlation information to associate subsets of data elements in the at least one second source vector operand with individual first source vector operands allows the at least one second source vector operand to be defined such that multiple vectors are effectively compressed into one source vector operand. Moreover, using the correlation information in this way provides freedom over how the multiple vectors are compressed into a single second source vector operand—for example, the correlation information allows the multiple vectors to be compressed so that data elements from any one of the multiple vectors can occupy any data element positions in the at least one second source vector operand—including consecutive and/or non-consecutive data elements.

Providing an instruction which supports execution of multiple outer product operations based on a source vector operand which may comprise data elements from multiple vectors that have been compressed into a smaller number of source vector operands can be advantageous in a number of scenarios. In one particular, non-limiting example, this may allow vectors which comprise one or more “zero” elements to be represented in a more compact form.

For example, since an outer product operation relies on multiplication—e.g. multiplying each data element in one vector by each data element in another vector—and since multiplication of any number by zero is zero, it is possible to effectively compress the input vectors for an outer product operation by removing some or all zero elements. One might assume that it is necessary to re-insert vector elements equal to zero into an input vector before performing the outer product operation(s), since otherwise corresponding elements of the result vector (e.g. which would have zero values) may be removed from the resulting outer product (leading to an incorrect result). However, the approach of the present technique—in which correlation information is used to identify which first source vector operands correspond with which elements in one or more second source vector operands—can allow input vector elements equalling zero to be removed from one or more source vector operands without changing the result of the outer product operation.

Accordingly, the present technique can allow such vectors to be represented in such a way that they can take up less space in any data storage structures storing the compressed operand (e.g. by removing data elements equal to zero from the vectors, so that the total number of data elements to be recorded—and hence the space in the storage structures needed to store those structures—is reduced). Reducing the amount of space taken up in storage provides numerous advantages, including reduced energy consumption if the data is stored in volatile storage and reduced latency and power consumption in loading, manipulating and storing the vectors. Further, by reducing the number of data elements in one or more of the source vectors, the total number of multiplications to be performed is reduced leading to reduced overall latency associated with the operation and to increased data throughput.

Hence, providing support in the instruction set architecture (ISA) for the MOP instruction can provide significant improvements in performance in a data processing apparatus.

It should be appreciated that it is not essential for the at least one second source vector operand to represent a compressed form of multiple vectors, or for those multiple vectors to comprise zeroes in one or more data elements. This is just one example of how the MOP instruction could be used to improve performance and reduce power consumption.

It should be appreciated that while the results generated by executing the MOP instruction are equivalent to calculating multiple outer product operations, the order in which individual data elements of each vector operand are used/consumed by the processing circuitry when executing the MOP instruction is a matter of implementation. For example, the outer product operations do not necessarily need to be performed one at a time (e.g. by considering each first source vector operand in turn). Instead, in at least some example implementation of the present technique, each data element in the at least one second source vector operand could be considered in turn (e.g. for a given data element in the at least one second source vector operand, selecting an appropriate first source vector operand). In other implementations, all of the data elements in the at least one second source vector can be considered in parallel, with a corresponding first source vector operand being selected in parallel for each element of the second source operand. These approaches—where a first source vector operand is selected for each data element in the at least one second source vector—can be more efficient, since they may only require a single pass of each second source vector operand to be made, rather than having to scan through each second source vector operand multiple times (as may be the case if the outer product operations are performed one at a time). However, it will be appreciated that other implementations can also be used to generate an equivalent result.

In some examples, the apparatus comprises array storage circuitry comprising storage elements to store data elements, the array storage circuitry being arranged to store at least one two dimensional (2D) array of data elements accessible to the processing circuitry when performing the vector operations. In such examples, the multiple-outer-product instruction may specify a given two dimensional array of data elements within the array storage forming a destination operand, and the processing circuitry may be configured to perform the associated outer product operation for a given first source vector operand by multiplying each data element of the given first source vector operand by each data element in the subset of data elements of the at least one second source vector operand in order to generate a plurality of outer product result elements, and using each outer product result element to update a value held in an associated storage element within the given two dimensional array of storage elements.

Array storage circuitry—which could, for example, comprise a set of array registers—can provide a useful mechanism for performing certain types of operations, for example outer product operations. In particular, the matrix of data elements produced as a result of performing an outer product operation can be stored within associated data elements of a 2D array represented in the array storage circuitry.

However, the inventors of the present technique realised that in some example use cases, when performing an outer product operation using two source vectors, it may be the case that some of the elements in one or both of the source vectors are zero, as noted above. This can result in inefficient use of the storage elements of 2D array, since a significant number of those storage elements may not then be used, or will only be used to store a zero value, and also can result in inefficient use of the resources of the hardware components forming the processing circuitry (which may be capable of performing computations to produce results for each of the storage elements). However, in accordance with the techniques described herein, a single instruction (namely the MOP instruction discussed above) can be defined that, through the use of correlation information associating subsets of data elements in the at least one second source vector operand with corresponding first source vector operands, enables multiple outer product operations to be performed, with the results of each outer product operation being stored within associated storage elements of the two-dimensional (2D) array. This can significantly improve throughput (as noted above), whilst also making more efficient utilisation of the available storage elements within the array storage.

It should be noted that there need not necessarily be a 1:1 correlation between each outer product result and an associated storage element in the 2D array. For example, in some cases multiple outer product results might be used to determine the value held in a given storage element, with extra operations such as accumulation (addition) operations being performed to combine the multiple outer product results.

In some examples, the processing circuitry comprises multiplication circuitry to generate each outer product result when performing the plurality of outer product operations, and multiplexer circuitry associated with the multiplication circuitry, the multiplexer circuitry to select, under control of the correlation information, a selected data element of the plurality of first source vector operands and a selected data element of the at least one second source vector operand to be multiplied in order to generate an associated outer product result element.

For example, the multiplication circuitry could include a multiplier circuit—e.g. this could be a simple multiplier for multiplying together two values or a multiply-accumulate (MAC) circuit, which multiplies together two values and adds the result to an accumulate value—associated with each storage element in the 2D array of storage elements. In the case of the MAC circuit, the same MAC circuit may both multiply together the selected data elements to generate the associated outer product result and add the associated outer product result to the value currently stored in the associated storage element of the array storage circuitry (which could be zero). However, there may not necessarily be a 1:1 correlation between each multiplier circuit or MAC circuit and each storage element in the 2D array—for example, there could be one multiplier/MAC per storage element (in which case it may be possible for the outer product result to be stored in each storage element to be calculated in parallel), or there may be less than one multiplier/MAC per storage element (in which case, each multiplier/MAC is used to compute outer product results for multiple storage elements in series).

However, many multiplier circuits are provided, the provision of multiplexer circuits associated with the multiplication circuitry allows the data elements for each multiplication operation to be selected, hence enabling implementation of the MOP instruction of the present technique.

In some examples, the correlation information comprises at least one set of indices, and the at least one set of indices comprises an index associating each data element of the given second source vector operand with the corresponding first source vector operand.

For example, an index may be provided for each data element of the given second source vector operand. Alternatively, each index may be associated with a plurality of data elements in the given second source vector operand.

In some examples, the correlation information is provided by at least one correlation source operand specified by the multiple-outer-product instruction, and a given correlation source operand comprises, for each data element of the given second source vector operand, a corresponding element comprising the index associating that data element of the given second source vector operand with the corresponding first source vector operand.

Providing, in a set of indices that forms the correlation information, an index for each data element of the at least one second source vector provides a simple mechanism for determining which index corresponds to which data element of the second source vector operand, which can in turn simplify processing and, therefore, provide improvements in performance.

As a particular example, the set of indices may be stored as a multi-bit scalar value (e.g. in a scalar register or a predicate register), where each bit is associated with a different vector element in one of one or more vector registers. In another example, the set of indices may be stored as a vector (e.g. in a vector register), with each data element in the vector holding one or more indices for corresponding data elements in the at least one second source vector operand. It will be appreciated that these are just some examples of how the set of indices may be stored, and other examples are also possible.

In some examples, the correlation information comprises a set of indices for each second source vector operand.

For example, if the MOP instruction specifies a plurality of second source vector operands, it may also identify a separate set of indices for each second source vector operand. The number of sets of indices may, therefore, be at least as large as the number of second source vector operands.

In some examples, the at least one set of indices comprises a set of indices providing the correlation information for a plurality of second source vector operands.

Hence, instead of indicating a set of indices for each second source vector operand, it is also possible for each set of indices identified by the MOP instruction to provide correlation information for more than one second source operand. Hence, in this example, the number of sets of indices may be less than the number of second source vectors. Advantageously, in implementations where the size/width of registers used is fixed and relatively large, this allows the amount of storage space taken up by the correlation information to be reduced.

In some examples, the correlation information is provided by at least one correlation source operand specified by the multiple-outer-product instruction, and each element of a given correlation source operand comprises a plurality of indices, the plurality of indices comprising an index for a corresponding data element of each of the plurality of second source vector operands. Hence, in these examples, each element of the given correlation source operand provides multiple indices, including at least one index for each second source vector. In a particular example, the top bits in a given element could provide an index for a data element of a first source vector, while the bottom bits provide an index for a data element of a second source vector. This approach takes advantage of the fact that the indices might each be formed of fewer bits than there is space for in each element of a correlation source operand. Hence, multiple indices can be stored in each element of a correlation source operand, so that less storage space is needed to store the correlation information.

In some examples, each outer product operation performed by the processing circuitry is based on a different subset of data elements of the at least one second source vector operand.

For example, each subset of data elements of the at least one second source vector operand may comprise different data elements to each other subset (e.g. each outer product operation may be based on different data elements of the second source vector operand). In these examples, the subsets of data elements of the at least one second source vector operand used for any two of the outer product operations differ by at least one data element. Note that “data element” generally refers to a particular data element position in a vector operand, rather than the specific numerical value held in that position. Hence, the numerical values of the data elements in different subsets might not necessarily differ, since it is possible that multiple data elements in a given source vector operand hold data with the same numerical value. Further, note that the subsets may differ by more than one data element-as a particular example, each data element in the at least one second source vector operand may be part of at most one subset of data elements.

In this way, multiple vectors can be represented in each second source vector operand, with each subset representing a different vector, and the multiple outer product operations can be performed based on the multiple vectors.

In some examples, the multiple-outer-product instruction comprises a sum-of-outer-products instruction, such that multiple outer product results have the same associated storage element within the given two dimensional array of storage elements, and the processing circuitry is configured to combine those multiple outer product results in order to update the value held in the associated storage element.

There are many possible applications for the MOP instruction, but in this example the MOP instruction is a sum-of-outer-products instruction (which could also be referred to as a “sum-of-multiple-outer-products instruction, SMOP), execution of which involves accumulating multiple outer product results into a single storage element of the 2D array. This variation of the MOP instruction can be advantageous, because it allows two matrices to be multiplied together in response to a single instruction.

In some examples, the apparatus comprises a set of vector registers accessible to the processing circuitry, wherein each vector register is arranged to store a vector comprising a plurality of data elements, and the plurality of first source vector operands and the at least one second source vector operand comprise vectors contained within vector registers of the set of vector registers.

A vector is a one-dimensional (1D) array comprising multiple (more than one) data elements. Mathematically, one might represent a vector of data elements as a single column or a single row of data elements; in a data processing system such as the apparatus in this example, the data elements of a vector are stored within a single vector register. Vector operands contrast with scalar operands, since each scalar operand comprises a single data item (e.g. each data element in a vector may be a scalar operand). Storing and manipulating (performing operations on) data elements in the form of vectors is advantageous because it allows multiple data elements to be operated on in parallel (e.g. using single-instruction-multiple-data (SIMD) processing). This can greatly improve performance, especially when performing operations on large arrays of data (e.g. matrix multiplication), where the ability to operate on multiple data elements in response to a single instruction can significantly improve performance by increasing throughput.

In some examples, the apparatus comprises a set of predicate registers accessible to the processing circuitry, wherein each predicate register is arranged to store predicate information comprising a plurality of elements, each element providing a predicate value, and the correlation information is stored within at least one predicate register of the set of predicate registers.

A data processing system—such as the apparatus of this example—may be provided with a set of predicate registers to store predicates (e.g. predicate information). Each predicate may, for example, be a mask of true/false (e.g. 1/0) values to be used in vector processing—for example, a predicate may indicate which data elements in a vector should and should not be operated on. This example makes use of the predicate registers for another purpose: storing the correlation information. This approach is advantageous because it makes use of circuitry (the predicate registers) which may already have been used to perform the outer product operations if each subset of data elements was provided in a separate vector register (e.g. to predicate out the zero values). Hence, this approach provides the correlation information without taking up additional storage space (e.g. taking up an additional architectural register, or additional space in memory, a cache or some other storage structure).

In some examples, the data elements in each second source vector operand represent data values from a plurality of rows and a plurality of columns of a source matrix.

As mentioned above, there are a number of scenarios in which the MOP instruction of the present technique may be useful. However, in a particular example, the MOP instruction may be used in matrix multiplication. In this example, each subset of the data elements in the at least one second source vector operand may represent a different row/column of a source matrix, and hence the present technique provides a more compact representation of the matrix.

In some examples, each element of the given correlation source operand is arranged to enable reconstruction of the source matrix from the at least one second source vector operand. For example, each element of the given correlation source operand may indicate which row/column of the original matrix one or more corresponding elements of the second source vector operand(s) came from. As a particular example, each element could be a bitmap of 1s and 0s, indicating which rows/columns of the original matrix held non-zero values (e.g. if the original matrix had two rows and the first bitmap is (1, 0), this might indicate that a first data element in a given second source vector operand represents a first data element of a first row of the matrix). An advantage of this approach is that it captures information about the original matrix format, so it is simple to decompress the second source vector operand(s) back into the original matrix.

In some examples, each data element in each second source vector operand is associated with a corresponding first dimension in the source matrix, wherein the corresponding first dimension comprises a corresponding row or a corresponding column in the source matrix, and each data element in each second source vector operand provides a data value selected from among the data values in the corresponding first dimension in the source matrix.

For example, the first data element in a given second source vector operand may be the first data element in a given row/column of the source matrix, and the correlation information may indicate which row/column the data element came from. Hence, in this way, a matrix made up of multiple rows/columns (e.g. multiple vectors) can be compressed into a smaller number of vector operands.

In some examples, the source matrix comprises a matrix with N:M structured sparsity wherein each defined group of M data values in the source matrix comprises at most N non-zero data values.

In a matrix with structured sparsity, specific (e.g. defined) groups of M data elements are constrained to have at most N non-zero values. This could be as a result of “pruning” an ANN, which may result in some of the data elements in a matrix being replaced with zeroes. The values of N and M are implementation dependent—for example ratios of 2:4 and 4:8 are common; more generally, one may use a ratio in which M=2N, or any other ratio, provided that N is less than M (N<M).

When a matrix has structured sparsity, it is possible to compress the matrix to take up less storage space by removing the zero values; in this way, the amount of storage space taken up by the matrix is reduced (which leads to improved performance and reduced power consumption, particularly when loading/storing the data elements). One might think that a downside of this approach is that additional processing is required to decompress the second source vector(s) back into the source matrix before any data processing operations (e.g. outer product operations) are performed on the data elements. However, the inventors realised that these compressed matrices could be used as operands for a MOP instruction, in combination with correlation information indicating which rows or columns of the source matrix the data elements came from. In this way, not only is the amount of storage space taken up by the matrix reduced, but the latency involved in performing a matrix multiplication is reduced (leading to a further improvement in performance) since multiple outer product operations can be performed in response to a single MOP instruction.

It should be noted that each group of M data elements in the source matrix is a defined/specific group—not just any group of M elements in the source matrix can be used. For example, a given group of M elements may be taken in one dimension (e.g. a row or a column) and aligned (e.g. if M=4, the first four elements in a given row may form one group).

In some examples, the source matrix comprises a matrix of weights or a matrix of activations for use in execution of an artificial neural network (ANN).

As noted above, the nodes of an ANN are typically represented as matrices of weights, and these matrices can be large. Similarly, data input to the nodes of the ANN typically takes the form of an activation matrix. Since these matrices can be large, and the number of nodes in an ANN is typically very large, a significant amount of data is typically needed to represent an ANN. Therefore, it can be useful to prune a neural network by clearing some of the data elements (e.g. setting them to zero) in the weight matrices. In particular, this may be done in a structured manner, in accordance with a defined N:M sparsity. This allows the matrices representing the ANN to be compressed into a smaller number of vector operands, providing all of the advantages discussed above (e.g. more efficient use of data storage, better performance and lower power consumption). It will be appreciated that these advantages are particularly significant when executing an ANN, given the large volume of data involved.

The techniques discussed above can be implemented in a hardware apparatus which has circuit hardware implementing the processing circuitry, instruction decoder circuitry and other apparatus features described above, which support the multiple-outer-product (MOP) instruction as part of the native instruction set architecture supported by the decode circuitry and processing circuitry.

However, in another example the same techniques may be implemented in a computer program (e.g. an architecture simulator or model) which may be provided for controlling a host data processing apparatus to provide an instruction execution environment for execution of instructions from target code. The computer program may include instruction decoding program logic for decoding instructions of the target code so as to control a host data processing apparatus to perform data processing including performing vector operations. Hence, the instruction decoding program logic emulates the functionality of the instruction decoder (instruction decoder circuitry) of a hardware apparatus as discussed above. The program may also include processing program logic to, when executed on the host data processing apparatus, perform the data processing (and hence emulate the functionality of the processing circuitry described above). Also, the program may include register maintenance program logic which maintains a data structure (within the memory or architectural registers of the host apparatus) which represents (emulates) the architectural registers of the instruction set architecture being simulated by the program—for example, these could include any or all of vector registers, scalar registers, array registers and predicate registers. The instruction decoding program logic includes support for the MOP instruction which has the same functionality as described above for the hardware example. Hence, such a simulator computer program may present, to target code executing on the simulator computer program, a similar instruction execution environment to that which would be provided by an actual hardware apparatus capable of directly executing the target instruction set, even though there may not be any actual hardware providing these features in the host computer which is executing the simulator program. Hence, by providing a simulation of the apparatus described above, the simulator computer program provides all of the advantages discussed above in relation to the apparatus. In addition, the simulation can be useful for executing code written for one instruction set architecture on a host platform which does not actually support that architecture. Also, the simulator can be useful during development of software for a new version of an instruction set architecture while software development is being performed in parallel with development of hardware devices supporting the new architecture. This can allow software to be developed and tested on the simulator so that software development can start before the hardware devices supporting the new architecture are available.

The simulator program may be stored on a storage medium, and that storage medium may be transitory or non-transitory.

Particular embodiments will now be described with reference to the figures.

FIG. 1 schematically illustrates a data processing system 10 comprising a processor 20 coupled to a memory 30 storing data values 32 and program instructions 34. The processor 20 includes an instruction fetch unit 40 for fetching program instructions 34 from the memory 30 and supplying the fetched program instructions to instruction decoder circuitry 50. The decoder circuitry 50 decodes the fetched program instructions and generates control signals to control processing circuity 60 to perform processing operations upon data values held within storage elements of register storage 65 as specified by the decoded vector instructions. As shown in FIG. 1, the register storage 65 may be formed of multiple different blocks. For example, a scalar register file 70 may be provided that comprises a plurality of scalar registers that can be specified by instructions, and similarly a vector register file 80 may be provided that comprises a plurality of vector registers that can be specified by instructions.

As also shown in FIG. 1, the processor 20 can access an array storage 90. In the example shown in FIG. 1, the array storage 90 is provided as part of the processor 20, but this is not a requirement. In various examples, the array storage can be implemented as any one or more of the following: architecturally-addressable registers; non-architecturally-addressable registers; a scratchpad memory; and a cache.

The processing circuitry 60 may in one example implementation comprise both vector processing circuitry and scalar processing circuitry. A general distinction between scalar processing and vector processing is as follows. Vector processing may involve applying a single vector processing instruction to data elements of a data vector having a plurality of data elements at respective positions in the data vector. The processing circuitry may also perform vector processing to perform operations on a plurality of vectors within a two dimensional array of data elements (which may also be referred to as a sub-array) stored within the array storage 90. Scalar processing operates on, effectively, single data elements rather than on data vectors. Vector processing can be useful in instances where processing operations are carried out on many different instances of the data to be processed. In a vector processing arrangement, a single instruction can be applied to multiple data elements (of a data vector) at the same time. This can improve the efficiency and throughput of data processing compared to scalar processing.

The processor 20 may be arranged to process two dimensional arrays of data elements stored in the array storage 90. The two-dimensional arrays may, in at least some examples, be accessed as one-dimensional vectors of data elements in multiple directions. In one example implementation, the array storage 90 may be arranged to store one or more two dimensional arrays of data elements, and each two dimensional array of data elements may form a square array portion of a larger or even higher-dimensioned array of data elements in memory.

The register storage 65 also includes a predicate register file 75. This stores predicate information (e.g. masks) for use in data processing operations (e.g. to mask out certain data elements of a vector so that they are excluded from a particular processing operation).

FIG. 2 shows an example of the architectural registers 65 of the processor 20 that may be provided in one example implementation. The architectural registers (as defined in the instruction set architecture (ISA)) may include a set of scalar registers (not shown) and a set of predicate registers 100 for storing predicate information. The predicate registers may also store correlation information for executing multiple-outer-product (MOP) instructions, as will be discussed below. For example, there may be a certain number of predicate registers 100 provided, for example 16 registers P0-P15 in this example. The predicate registers may have a fixed size, although depending on the datatype of the elements stored in the predicate registers, some bits in each element may not necessarily be used.

Also, the architectural registers available for selection by program instructions in the ISA supported by the decoder 50 may include a certain number of vector registers 105 (labelled Z0-Z31 in this example). Of course, it is not essential to provide the number of predicate/vector registers shown in FIG. 2, and other examples may provide a different number of registers specifiable by program instructions. Each vector register may store a vector operand comprising a variable number of data elements, where each data element may represent an independent data value. In response to vector processing (SIMD) instructions, the processing circuitry may perform vector processing on vector operands stored in the registers to generate results. For example, the vector processing may include lane-by-lane operations where a corresponding operation is performed on each lane of elements in one or more operand vectors to generate corresponding results for elements of a result vector. When performing vector or SIMD processing, each vector register may have a certain vector length VL where the vector length refers to the number of bits in a given vector register. The vector length VL used in vector processing mode may be fixed for a given hardware implementation or could be variable. The ISA supported by the processor 20 may support variable vector lengths so that different processor implementations may choose to implement different sized vector registers but the ISA may be vector length agnostic so that the instructions are designed so that code can function correctly regardless of the particular vector length implemented on a given CPU executing that program. The vector registers Z0-Z31 may also serve as operand registers for storing the vector operands which provide the inputs to processing and accumulate operations performed by the processing circuitry 60 on two dimensional arrays of data elements stored within the array storage 90.

As shown in FIG. 2, the architectural registers also include a certain number NA of array registers 110 forming the earlier-mentioned array storage 90, ZA0-ZA(NA-1). Each array register can be seen as a set of register storage for storing a single 2D array of data elements, e.g. the result of a processing and accumulate operation. However, processing and accumulate operations may not be the only operations which can use the array registers. The array registers could also be used to store square arrays while performing transposition of the row/column direction of an array structure in memory. When a program instruction references one of the array registers 110, it is referenced as a single entity using an array identifier ZAi, but some types of instructions (e.g. data transfer instructions) may also select a sub-portion of the array by defining an index value which selects a part of the array (e.g. one horizontal/vertical group of elements). In practice the physical implementation of the register storage corresponding to the array registers may comprise a certain number NR of array vector registers, ZAR0-ZAR(NR-1), as also shown in FIG. 2. The array vector registers ZAR forming the array register storage 110 may be a distinct set of registers from the vector registers Z0-Z31 used for SIMD processing and vector inputs to array processing. Each of the array vector registers ZAR may have the vector length VL, so each array vector register ZAR may store a 1D vector of length VL, which may be partitioned logically into a variable number of data elements. For example, if VL is 512 bits then this could be a set of 64 8-bit elements, 32 16-bit elements, 16 32-bit elements, 8 64-bit elements or 4 128-bit elements, for example. It will be appreciated that not all of these options would need to be supported in a given implementation. By supporting variable element size this provides flexibility to handle calculations involving data structures of different precision. To represent a 2D array of data, a group of array vector registers ZAR0-ZAR(NR-1) can be logically considered as a single entity assigned a given one of the array register identifiers ZA0-ZA(NA-1), so that the 2D array is formed with the elements extending within a single vector register corresponding to one dimension of the array and the elements in the other dimension of the array striped across multiple vector registers.

As discussed above, the processing circuitry 60 is arranged, under control of instructions decoded by decoder circuitry 50, to access the scalar registers 70, the vector register 80 and/or the array storage 90. Further details of this latter arrangement will now be described with reference FIG. 3A, which merely provides one illustrative example of how the array storage may be accessed, in particular considering access to a square 2D array within the array storage.

In the illustrated example, a square 2D array within the array storage 90 is arranged as an array 205 of n×n storage elements/locations 200, where n is an integer greater than 1. In the present example, n is 16 which implies that the granularity of access to the storage locations 200 is 1/16th of the total storage of the 2D array, in either horizontal or vertical array directions.

From the point of view of the processing circuitry, the array of n×n locations are accessible as n linear (one-dimensional) vectors in a first direction (for example, a horizontal direction as drawn) and n linear vectors in a second array direction (for example, a vertical direction as drawn). Hence, the n×n storage locations are accessible, from the point of view of the processing circuitry 60, as 2n linear vectors, each of n data elements.

The array of storage locations 200 is accessible by access circuitry 210, 220, column selection circuitry 230 and row selection circuitry 240, under the control of control circuitry 250 in communication with at least the processing circuitry 60 and optionally with the decoder circuitry 50.

With reference to FIG. 3B, the n linear vectors in the first direction (a horizontal or “H” direction as drawn), in the case of an example square 2D array designated as “ZA1” (noting that as discussed below, there could be more than one such 2D array provided within the array storage 90, for example ZA0, ZA1, ZA2 and so on) are each of 16 data elements 0 . . . F (in hexadecimal notation) and may be referenced in this example as ZA1H0 . . . ZA1H15. The same underlying data, stored in the 256 entries (16×16 entries) of the array storage 90 ZA1 of FIG. 3B, may instead be referenced in the second direction (a vertical or “V” direction as drawn) as ZA1V0 . . . ZA1V15. Note that, for example, a data element 260 is referenced as item F of ZA1H0 but item 0 of ZA1V15. Note that the use of “H” and “V” does not imply any spatial or physical layout requirement relating to the storage of the data elements making up the array storage 90, nor does it have any relevance to whether the 2D arrays within the array storage store row or column data in any example application.

FIG. 4A illustrates an outer product operation. The outer product operation takes, as inputs, two vectors A and B, which may be stored in the vector register file as discussed above. The result of the outer product operation is a matrix (e.g. a 2D array) A⊗B. As shown in the figure, each data element in the output matrix is determined by multiplying together corresponding data elements in each input vector—for example, the top-left element in the result matrix is calculated by multiplying together element a₀ of vector A and element b₀ of vector B. In populating the result matrix, each data element in vector A is multiplied by each data element in vector B; hence, the result of calculating an outer product operation of a vector of n elements and a vector of m elements is an n×m matrix.

FIG. 4B illustrates a matrix multiplication operation. In particular, FIG. 4B shows an operation involving multiplying together two matrices C and D (which could, for example, be stored in vector registers (e.g. one row or one column being held in each register) or in array storage circuitry) to generate a matrix CD. As can be seen from the figure, the result of multiplying together two n×n matrices is an n×n matrix (more generally, an n×k matrix multiplied by an k×m matrix will result in an n×m matrix).

There are several ways to calculate the elements of the output matrix CD, but the technique that is typically employed by processors is to perform multiple outer product operations and accumulate (add) together the results. For example, to perform the matrix multiplication illustrated in FIG. 4B, processing circuitry may first calculate the outer product of the left-most column, i, of matrix A and the top row, w, of matrix B to generate 16 outer product results and populate a 4×4 array in the array storage with the outer product results. The processing circuitry may then calculate an outer product of the next column, j, of matrix A with the next row, x, of D, to generate another 16 outer product results which are added to the outer product results already stored in the array. This process can then be repeated for the last two pairs of vectors (k⊗y and l⊗z), to generate the final result CD.

Hence, it can be seen that a matrix multiplication can be carried out by performing multiple outer product operations and accumulating the results—for example, this could be by performing one or more multiple-outer-product instructions. It should be noted that the order in which the pairs of vectors are multiplied together is not limited to the order described above—the outer products can be calculated in any order. In addition, it is not necessary to perform the outer product operations one after the other.

As can be seen from the example in FIG. 4B, matrix multiplication involves performing a significant number of operations—for example, multiple outer product operations may be performed, each of which involves multiple multiplication operations. As a result, matrix multiplication can be a particularly time-and energy-consuming process. This is especially true in situations such as execution of an artificial neural network (ANN), which may comprise performing a significant number of matrix multiplications. Hence, there is an interest in improving the performance of matrix multiplication operations.

FIG. 5 shows a matrix with N:M structured sparsity. In the matrix shown in FIG. 5, a shaded element represents a non-zero element, while a blank (unshaded) element represents a zero element. In the particular example shown in FIG. 5, a 10×11 matrix with 3:5 sparsity is shown. More particularly, each column of ten data elements is considered to comprise two groups of M=5 consecutive data elements, of which at most N=3 are non-zero (e.g. the shaded data elements).

As explained above, structured sparsity can be introduced into a matrix (e.g. by clearing/setting to zero some of its elements) in order to reduce the number of data elements in the matrix that will be involved in at least some matrix operations performed on that matrix. In addition, the inventors realised (as will be discussed in more detail below) that introducing structured sparsity into a matrix can allow the matrix to be compressed into a smaller number of vector operands, which reduces the amount of space taken up by the matrix.

FIGS. 6A and 6B show further examples of sparse matrices for information-as in FIG. 5, a shaded element represents a non-zero element, while a blank (unshaded) element represents a zero element. In particular, FIG. 6A shows a matrix with 2:4 structured sparsity (N=2, M=4) and FIG. 6B shows a matrix with 4:8 structured sparsity (N=4, M=8). Note that, while both FIG. 6A and FIG. 6B show 8×8 matrices in which at most four data elements per column are non-zero, the matrix shown in FIG. 6A is further constrained in that each group of 4 data elements in a column (e.g. the first four elements in a column or the last four elements in a column) has at most two non-zero elements. This can be seen by comparing, for example, the left-most column of each matrix—in the matrix of FIG. 6B, the first four data elements in the left-most column are all non-zero; this is not permitted in a matrix with 2:4 structured sparsity, where (as shown in the left-most column of the matrix in FIG. 6A) at most 2 of these four elements can be non-zero.

Data processing operations can be performed on sparse matrices just as they can be performed on other matrices. For example, FIG. 7 illustrates how an array of multiply-accumulate (MAC) units can be used to calculate the result of multiplying an 8×4 matrix of activations by a 4×8 matrix (with 2:4 sparsity) of weights (e.g. the weights at a given node of an ANN). Predicate information may be used to mask out the zero values, for example.

However, as explained above, the inventors realised that there are several advantages to compressing a sparse matrix into a smaller number of vector operands. An example of this is shown in FIG. 8A, where a 4×8 matrix with 2:4 sparsity is compressed into two vector operands. In particular, FIG. 8 shows how a matrix that originally takes up four vector registers (Z8, Z9, Z10, Z11) can be compressed into two vector registers (Z4, Z5), each of which stores data elements from one or more rows of the source matrix. This frees up two vector registers in the vector register file (and/or an equivalent amount of space in memory/another data store).

A set of indices Id is held for each of the compressed source vector operands, which can be used to reconstruct the source matrix. For example, the indices may indicate which row of the source matrix each element in Z4 or Z5 comes from.

Another example of how a sparse matrix can be compressed into a smaller number of vector operands is shown in FIG. 8B, where an 8×8 sparse matrix (with 4:8 structured sparsity) is compressed into four vector operands.

Once a sparse matrix has been compressed, the inventors realised that a multiple-outer-product (MOP) operation can be performed on the resulting vector operands without first decompressing them to form the original matrix. This is shown in FIG. 9, where an 8×4 matrix of activations is multiplied by a 2×8 compressed matrix of weights using multiplication circuitry 255 (e.g. this could be a MAC array). For example, this may be performed as two MOP operations, one based on Z4 and one based on Z5, or as a sum-of-outer-products (SMOP) operation.

To multiply together the matrices, four outer product operations are performed. These involve calculating an outer product of each column of the matrix of activations (e.g. the vectors Z0, Z1, Z2, Z3) with data elements in Z4 and Z5 that have the same shading. For example, this means that the first, second, fourth and sixth data elements from the left in Z5 are multiplied by corresponding elements in Z3; the third, 5^{th} and 7^{th} elements from the left in Z5 and the first element from the left in Z4 are multiplied by corresponding elements in Z2, and so on. The indices can be used to identify which vector in the first group of vector operands (Z0:Z3) each data element in the second group of vector operands (Z4:Z5) should be multiplied by.

The multiplication circuitry 255 shown in FIG. 9 comprises a number of multiplexers 270, each of which provides an input into a corresponding multiplier circuit (not shown). In this particular example, an 8×8 array of multiplexers 270 is provided, including a multiplexer (and corresponding multiplier) for each multiplication to be performed. Each multiplexer takes, as inputs, a data element from a corresponding position in each of the activation vectors Z0 to Z3, and selects one of the data elements for multiplication with a data element in a corresponding position in Z4 or Z5 based on the correlation information. It will be appreciated, however, that in other examples there may be fewer multiplexers and multipliers, with each multiplexer/multiplier pair being used to perform several of the multiplication operations to be performed.

Accordingly, as discussed above, the apparatus of the present technique is configured to support execution of a multiple-outer-product (MOP) instruction that identifies, as inputs, a plurality of first vector operands (e.g. vector registers Z0:Z3 in this case), at least one second source vector operand (e.g. Z4 and/or Z5) and correlation information (e.g. one or both of the sets of indices).

It should be noted that, while the Figures show examples where the weights matrix is a compressed sparse matrix, it is equally possible for the activations matrix to be compressed sparse matrix instead of or in addition to the weights matrix. More generally (since multiplying activations and weights matrices is just one example use case for the present technique), it does not matter whether the first (group of) vector operand(s) or the second (group of) vector operand(s) specified by the MOP instruction represent a compressed sparse matrix—it can be either or both.

FIG. 10 is a block diagram of an apparatus in accordance with one example implementation, illustrating how the processing circuitry is used to perform outer product operations. The vector register file 80 provides a plurality of vector registers that can be used to store vectors of data elements. As discussed earlier, the MOP instruction can be arranged to identify a plurality of first source vector operands 300 and at least one second source vector operand 320. The at least one second source vector operand 320 (and optionally also the plurality of first source vector operands 300) comprises multiple subsets of data elements, with each subset being for a different outer product operation. It should be noted that the terms “first” and “second” used herein to refer to the two source (groups of) vector operands are used purely as labels to distinguish between them, and do not imply any particular ordering with regards to how those operands are specified by the instruction. Hence, either of the source operand fields of the instruction may be used to specify the first source vector operands referred to above, and the other of the source operand fields will then be used to specify the second source vector operand referred to above.

Further, whilst in accordance with the techniques described herein at least one of the two source vector operands will comprise multiple subsets of data elements for use in different outer product operations, and the other source vector operand may not, it may also be the case in some example implementations that both source vector operands comprise multiple subsets of data elements. Similarly, more than one second source vector operand 320 may be specified, in addition to specifying a plurality of first source vector operands. In addition, the number of first source vector operands and the number of second source vector operands specified by the MOP are not limited to either one vector operand or two vector operands, but indeed more than two first/second vector operands may be specified (for example four vector operands or eight vector operands, etc.).

The MOP instruction also specifies correlation information, which identifies which data elements in the at least one second source vector operand 320 are to be multiplied by which vector operands in the plurality of first vector operands. In this example, the correlation information is stored in predicate registers 325 in the predicate register file 75, and hence the MOP instruction also identifies one or more predicate registers 325.

The processing circuitry 60 is controlled in dependence on control signals received from the decoder circuitry (decoder) 50, and when the decoder circuitry 50 decodes the earlier-mentioned MOP instruction, it will send control signals to the processing circuitry to control the processing circuitry to perform a plurality of computations to implement a plurality of outer product operations, wherein the plurality of outer product operations comprise, for a given first source vector operand, performing an associated outer product operation to calculate an outer product of the given first source vector operand with a subset of data elements of the at least one second source vector operand. As part of this process, those control signals will control selection circuitry 340 provided by the processing circuitry 60 to select the appropriate data elements to be processed by each outer product operation. Each outer product operation comprises multiplying each data element of an associated subset of data elements in the at least one second source vector operand by each data element in an associated first source vector operand, and then using each outer product result element to update a value held in an associated storage element within a given two-dimensional array 380 of storage elements within the array storage 90.

The selection circuitry 340 can be organised in a variety of ways, but in one example implementation comprises multiplexer circuitry provided for each of a plurality of multipliers used to generate an outer product result from two input data elements, that multiplexer circuitry being used to select the appropriate two input data elements for each multiplier.

The selected input data elements are then forwarded to multiplication circuitry 350, which as noted above may in one example implementation comprise a multiplier circuit for each outer product result to be produced. Each outer product result element is produced by multiplying the two input data elements provided to the corresponding multiplier within the multiplication circuitry 350. The outer product result element may be provided directly to array update circuitry 370 used to update the storage elements within the 2D array 380, each outer product result element having an associated storage element within the 2D array 380 and being used to update the value held in that associated storage element. However, it is often the case that the outer product operations being performed are accumulate operations, and each outer product result element generated is combined with the existing value stored in the associated storage element of the 2D array 380 (for example by adding the outer product result to the existing value or subtracting the outer product result from the existing value), using the optional accumulate circuitry 360. Whilst the multiplication circuitry 350 and optional accumulate circuitry 360 are shown as separate blocks in FIG. 10, in one example implementation they may be provided as a combined block formed of multiply accumulate circuits.

The array update circuitry 370 is used to control access to the relevant storage elements within the 2D array 380, so as to ensure that each value received by the array update circuitry is used to update the associated storage element within the 2D array 380.

Outer product operations are usefully employed within data processing systems for a variety of different reasons, and hence the ability to perform multiple outer product operations in response to a single instruction can provide significant performance/throughput improvements, as well as making more efficient use of the available storage resources provided by the two-dimensional arrays within the array storage 90. Merely by way of example as to how outer product operations may be used, they can be used to implement matrix multiplication operations. Matrix multiplication may for example involve multiplying a first m×k matrix of data elements by a k×n matrix of data elements to produce an m×n matrix result of data elements. This operation can be decomposed into a plurality of outer product operations (more particularly k outer product operations, where k may be referred to as the depth), where each outer product operation involves performing a sequence of multiply accumulate operations to multiply each data element of an m vector of data elements from the first matrix by each data element of an n vector of data elements from the second matrix to produce an m×n matrix of result data elements stored within the 2D array. The results of the plurality of outer product operations can be accumulated within the same 2D array in order to produce the m×n matrix that would have been generated by performing the earlier-mentioned matrix multiplication.

Matrix multiplication has a number of potential applications. In addition to application in executing an ANN as noted above, matrix multiplication may be employed in, for example, image processing.

FIG. 11A illustrates how an outer product result element may be associated with a particular storage element in the 2D array. In the example of FIG. 11A, a data element 570 from the first source vector operand is multiplied by a data element 572 from the second source vector operand using the multiply function 574, producing an outer product result element which is then subjected to an accumulate operation by the accumulate function 576 to add that outer product result to the current value stored in the associated storage element 578 (or to subtract that outer product result from the current value stored in the associated storage element 578) in order to produce an updated value that is then stored in the associated storage element.

FIG. 11B illustrates a sum of outer products operation where two outer product result elements are associated with the same storage element within the 2D array. In this example, a data element 580 from the first source vector operand is multiplied by a data element 582 from the second source vector operand using the multiply function 584 in order to produce a first outer product result element. Similarly, a data element 586 from the first source vector operand and a data element 588 from the second source vector operand are multiplied by the multiply function 590 in order to produce a second outer product result element. The two outer product results are then added together using the add function 592, and an accumulate function 594 is performed in order to produce an updated data value for storing in the associated storage element 596. Hence, it will be appreciated that in some implementations there can be more than one outer product result element associated with the same storage element in the 2D array.

FIG. 12 is a diagram schematically illustrating fields that may be provided within the MOP instruction, in accordance with one example implementation. An opcode field 605 is used to identify the type of instruction, in this case identifying that the instruction is a MOP instruction.

One or more control information fields 610 can be provided, for example to identify one or more predicates as referred to earlier. In addition, a field 615 identifies the correlation information to be used in the operation—for example, this could be an identifier of a register (e.g. a predicate register) storing the correlation information. Note that this is separate from any predicate information held in the control information field 610, which is to be used as a predicate/mask in the operation. The field 620 is then used to identify the plurality of first source vector operands (for example by specifying vector registers within the vector register file 80, wherein one or more vector operands are implicitly associated with the identified register(s)). Similarly, a field 625 can be used to identify the one or more second source vector operands, again for example by specifying one or more vector registers within the vector register file 80. Note that this is just one example, and in fact either one of the fields 620, 625 can be used to specify the earlier-mentioned first source vector operands, with the other field then specifying the second source vector operand. Finally, the field 630 may be used to identify the destination 2D array within the array storage 90 that is to be used to store the matrices generated as a result of performing the multiple outer product operations specified by the multiple outer product instruction.

As noted above, there are multiple ways in which the correlation information can be represented. FIGS. 13 to 15 illustrate some examples of how the correlation information may be represented in one or more predicate registers.

FIG. 13 shows a first example in which each predicate register P0, P1 holds a set of indices for a corresponding vector register Z4, Z5, each set of indices forming the correlation information for its corresponding vector register. Each index in this example identifies the register of the source matrix (and hence indirectly identifies a row of the source matrix) that the corresponding data element came from, with the first (bottom) row being row “0” and the fourth (top) row being row “3”. For example, the left-most element in predicate register P0 (which holds the correlation information for vector register Z4 in this example) is “2”, indicating that the corresponding element (the left-most element) in vector register Z4 comes from the 3^{rd} row of the source matrix (e.g. from vector register Z10 in this example).

The right-hand side of FIG. 13 shows how the MOP instructions (identified as “FMOPA” instructions in this case) may be represented in this example. In this example, a separate MOP instruction is executed for each of the vector registers Z4, Z5, with each MOP instruction identifying:
a destination array (ZAi) into which the outer product results calculated by the processing circuitry are to be written;
the predicate register (P0 or P1) holding the indices to be used in executing the MOP instruction;
a plurality of first source vector registers (Z0 to Z3) holding the plurality of first source vector operands; and
a second source vector register (Z4 or Z5) holding the second source vector operand for the operation.

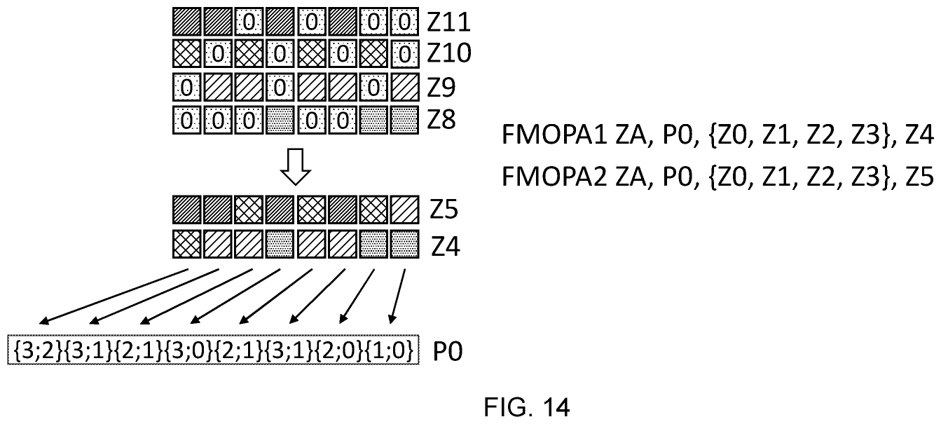

FIG. 14 shows another example of how the correlation may be represented; in this example, the same indices are used, but the indices for both Z4 and Z5 are stored in the same predicate register P0. This example takes advantage of the fact that the number of bits required to represent each index is typically significantly smaller than the number of bits available in each element of the predicate register—for example, the indices in this example are at most 2-bits long (the indices 0, 1, 2 and 3 are represented in binary as 00, 01, 10, and 11 respectively), whereas the number of bits in each element of a predicate register may be 4 or more. Hence, the inventors realised that the indices for the two vector registers Z4, Z5 can be packed into a single predicate register, reducing the number of predicate registers that are taken up by the correlation information. In particular, as shown in FIG. 14, the top-half (e.g. the top two bits) of each data element can be used to store the index for a corresponding data element of one of the vector registers (e.g. the top-half of the left-most element stores the value “3”, which is the index for the leftmost element in Z5), while the bottom-half (e.g. the bottom two bits) of each data element can be used to store the index for a corresponding data element of the other of the vector registers (e.g. the bottom-half of the left-most element stores the value “2”, which is the index for the leftmost element in Z4).

Hence, as shown by the instruction assembly syntax on the right-hand side of FIG. 14, this example requires two slightly different MOP instructions (i.e. an “FMOPA1” instruction and an “FMOPA2” instructions), with both identifying the same predicate register P0, but one causing the processing circuitry to read the top two bits of each element, and the other causing the processing circuitry to read the bottom two bits of each element. To distinguish between the two types of MOP instruction, each of the two MOP instructions could, for example, have a different opcode. Alternatively, the encoding of the two instructions could be different in some other way.

Hence, each MOP instruction in FIG. 14 specifies:
the destination array (ZAi);
the same predicate register (P0);
the plurality of first source vector registers (Z0 to Z3) holding the plurality of first source vector operands; and
the second source vector register (Z4 or Z5) holding the second source vector operand for the operation.

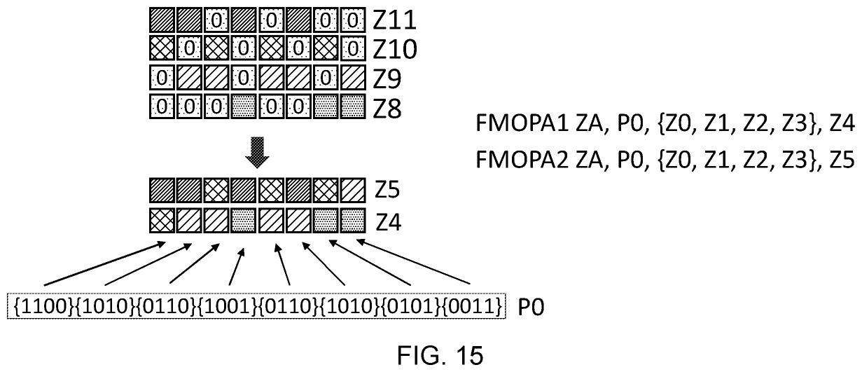

FIG. 15 shows another example of how the correlation information may be represented, in which the correlation information for two vector registers Z4, Z5 is compressed into a single predicate register P0. In this example, each data element in the predicate register P0 holds a bitmap indicating which data elements in a corresponding row of the source matrix held non-zero values. For example, the left-most data element in the predicate register reads “1100”, indicating that there are non-zero elements in the top two rows of the left-most column of the source matrix, and zero in the bottom two rows of the same column. From this, it can be determined that the left-most data elements in the vector registers Z4, Z5 are from the top two (2^{nd} and 3^{rd}) rows of the source matrix.

When executing the MOP instruction in this example, therefore, the processing circuitry determines a position of either the first or the second “1” in the corresponding bitmap to identify which of the first source vectors should be used in the associated outer product operation.

Each instruction specifies:
the destination array (ZAi);
the same predicate register (P0);
the plurality of first source vector registers (Z0 to Z3) holding the plurality of first source vector operands; and
the second source vector register (Z4 or Z5) holding the second source vector operand for the operation.

Note that, while FIGS. 14 and 15 show examples where a separate MOP instruction is executed for each second vector operand (Z4, Z5), it is also possible to define a single MOP instruction specifying both second vector operands.

As explained above, structured sparsity is an optimization technique for the inference of neural network models (and not for their training). It can thus be beneficial to support models using data in the Brain Floating Point (bfloat16/BF16) format and as signed, 8-bit integers (int8). As 2-way data interleaving is typically used in some data processors for outer products of bf16 data, the two vectors of weights (Z4, Z5) in e.g. FIG. 9 are packed into a single vector register (Zₘ) of bf16 elements, as shown in FIG. 16. Similarly, the 4 activation vectors (Z0:Z3) are packed into 2 vector registers (Zₙ, Zₙ₊₁). FIG. 16 illustrates the principle of a multi-register sum-of-outer-products scheme with bf16 elements. The predicate register could contain a list of indexes as shown in FIG. 14 or a bitmap as shown in FIG. 15.

As shown in FIG. 16, the MOP instruction in this example is a sum-of-outer-products (SMOPA) instruction, for performing elementary 2-way dot product operations. The SMOPA instruction in this example which specifies:
the destination array (ZAi);
the predicate register (Pᵢ);
the plurality of first source vector registers (Zₙ, Zₙ₊₁) holding the plurality of first vector operands; and
the second source vector register (Zₘ) holding multiple second source vector operands.

In the case of 8-bits data type (int 8 or uint 8), the base instruction is a sum-of-outer-products instruction with an accumulation on 32-bits. The elementary operations are 4-way dot products operating on 4-way interleaved data. As shown in FIG. 17, in the variant of the invention operating on 8-bits data, 2 source registers are used for the activations (left-hand operand) and one source register for the weights (right-hand operand). As 4 elements are selected among 8 elements in this variant of the instruction (e.g. 2 times 2 elements among 4), two predicate registers are used. Four 8-bit 4-to-1 multiplexers are provided in front of each multiplier to achieve a throughput of one operation per cycle.

The right-hand side of FIG. 17 illustrates the form of this variant of the MOP instruction. As shown, the MOP instruction in this example is a sum-of-outer-products instruction (SMOPA), which specifies:
the destination array (ZAi);
the predicate registers (P0, P1);
the plurality of first source vector registers (Zₙ, Zₙ₊₁) holding the plurality of first vector operands; and
the second source vector register (Zₘ) holding multiple second source vector

While FIG. 17 assumes a 2:4 sparsity pattern is used, in an alternative variant of the instruction, a 4:8 sparsity pattern is used with a bitmap to select source elements of the left operand. This variant would require 8-to-1, rather than 4-to-1, multiplexers. However, the form of the alternative variant of the instruction would be the same as the one shown in FIG. 17, since the operands would be identical.

In terms of usage of the instruction, the following is a code snippet illustrating how the instruction can be used:
LD1B (Z0-Z3), p0/Z, [&activations]
LD1B (Z4-Z5), p1/Z, [&weights]
LDR p2, [&indexes]
LDR p3, [&indexes]
SMOPA ZA0.S, P2, (Z0.H-Z1.H), Z4.H
SMOPA ZA1.S, P3, (Z0.H-Z1.H), Z5.H
SMOPA ZA2.S, P2, (Z2.H-Z3.H), Z4.H
SMOPA ZA3.S, P3, (22.H-Z3.H), Z5.H

FIG. 18 is a flow diagram illustrating steps performed on decoding a multiple outer product instruction in accordance with one example implementation. At step 650, it is determined whether a MOP instruction has been encountered. If not, then standard decoding of the relevant instruction is performed at step 655, with the processing circuitry then being controlled to perform the required operation defined by that instruction.

However, if a MOP instruction is encountered, then at step 660 that instruction is decoded in order to identify the source vector operands (e.g. the plurality of first source vector operands and the at least one second source vector operand), the destination 2D array, the correlation information, and the form of outer product that is to be performed (for example whether an accumulating outer product is being performed or a non-accumulating variant is being performed, and also for example whether normal outer product operations are to be performed or sum of outer products operations are to be performed).

Then, at step 665, the processing circuitry is controlled to perform the required outer product operations and to perform the required updates to the 2D array storage elements. As part of this process, selection circuitry is controlled to select the data elements for each multiplication operation dependent on the correlation information.

FIG. 19 illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 715, optionally running a host operating system 710, supporting the simulator program 705. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic—for example, the simulator program 705 may comprise processing program logic 720 to emulate the behaviour of the processing circuitry described above and instruction decode program logic to emulate the behaviour of the instruction decoder circuitry described above. Similarly, memory hardware, such as a register or cache, may be implemented in a simulated embodiment as a software data structure—in this particular example, array storage emulating program logic 722 is provided to emulate the array storage described above. In arrangements where one or more of the hardware elements referenced in the previously described embodiments are present on the host hardware (for example, host processor 715), some simulated embodiments may make use of the host hardware, where suitable.

The simulator program 705 may be stored on a computer-readable storage medium (which may be a non-transitory medium), and provides a program interface (instruction execution environment) to the target code 700 (which may include applications, operating systems and a hypervisor) which is the same as the interface of the hardware architecture being modelled by the simulator program 705. Thus, the program instructions of the target code 700, including the MOP described above, may be executed from within the instruction execution environment using the simulator program 705, so that a host computer 715 which does not actually have the hardware features of the apparatus discussed above can emulate these features.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
processing circuitry to perform vector operations; and
instruction decoder circuitry to decode instructions from a set of instructions to control the processing circuitry to perform the vector operations specified by the instructions, wherein:
the set of instructions comprises a multiple-outer-product instruction specifying a plurality of first source vector operands, at least one second source vector operand and correlation information associated with the at least one second source vector operand, wherein each vector operand comprises a plurality of data elements and, for a given second source vector operand, the correlation information is arranged to indicate, for each data element of the given second source vector operand, a corresponding first source vector operand;
the instruction decoder circuitry is responsive to the multiple-outer-product instruction to control the processing circuitry to perform a plurality of computations to implement a plurality of outer product operations, wherein the plurality of outer product operations comprise, for a given first source vector operand, performing an associated outer product operation to calculate an outer product of the given first source vector operand with a subset of data elements of the at least one second source vector operand; and
the processing circuitry is configured to select, for each data element of the at least one second source vector operand, a corresponding first source vector operand to be used when performing the associated outer product operation, in dependence on the correlation information.

2. The apparatus of claim 1, comprising array storage circuitry comprising storage elements to store data elements, the array storage circuitry being arranged to store at least one two dimensional array of data elements accessible to the processing circuitry when performing the vector operations,
wherein:
the multiple-outer-product instruction specifies a given two dimensional array of data elements within the array storage forming a destination operand; and
the processing circuitry is configured to perform the associated outer product operation for a given first source vector operand by multiplying each data element of the given first source vector operand by each data element in the subset of data elements of the at least one second source vector operand in order to generate a plurality of outer product result elements, and using each outer product result element to update a value held in an associated storage element within the given two dimensional array of storage elements.

3. The apparatus of claim 2, wherein the processing circuitry comprises:
multiplication circuitry to generate each outer product result when performing the plurality of outer product operations; and
multiplexer circuitry associated with the multiplication circuitry, the multiplexer circuitry to select, under control of the correlation information, a selected data element of the plurality of first source vector operands and a selected data element of the at least one second source vector operand to be multiplied in order to generate an associated outer product result element.

4. The apparatus of claim 1, wherein:
the correlation information comprises at least one set of indices; and
the at least one set of indices comprises an index associating each data element of the given second source vector operand with the corresponding first source vector operand.

5. The apparatus of claim 4, wherein:
the correlation information is provided by at least one correlation source operand specified by the multiple-outer-product instruction; and
a given correlation source operand comprises, for each data element of the given second source vector operand, a corresponding element comprising the index associating that data element of the given second source vector operand with the corresponding first source vector operand.

6. The apparatus of claim 4, wherein the correlation information comprises a set of indices for each second source vector operand.

7. The apparatus of claim 4, wherein the at least one set of indices comprises a set of indices providing the correlation information for a plurality of second source vector operands.

8. The apparatus of claim 7, wherein:
the correlation information is provided by at least one correlation source operand specified by the multiple-outer-product instruction; and
each element of a given correlation source operand comprises a plurality of indices, the plurality of indices comprising an index for a corresponding data element of each of the plurality of second source vector operands.

9. The apparatus of claim 1, wherein each outer product operation performed by the processing circuitry is based on a different subset of data elements of the at least one second source vector operand.

10. The apparatus of any preceding claim when dependent on claim 2, wherein: the multiple-outer-product instruction comprises a sum-of-outer-products instruction; and multiple outer product results have the same associated storage element within the given two dimensional array of storage elements, and the processing circuitry is configured to combine those multiple outer product results in order to update the value held in the associated storage element.

11. The apparatus of claim 1, comprising:
a set of vector registers accessible to the processing circuitry, wherein:
each vector register is arranged to store a vector comprising a plurality of data elements; and
the plurality of first source vector operands and the at least one second source vector operand comprise vectors contained within vector registers of the set of vector registers.

12. The apparatus of claim 11, comprising
a set of predicate registers accessible to the processing circuitry,
wherein:
each predicate register is arranged to store predicate information comprising a plurality of elements, each element providing a predicate value; and
the correlation information is stored within at least one predicate register of the set of predicate registers.

13. The apparatus of claim 1, wherein the data elements in each second source vector operand represent data values from a plurality of rows or a plurality of columns of a source matrix.

14. The apparatus of claim 13, wherein each element of the given correlation source operand is arranged to enable reconstruction of the source matrix from the at least one second source vector operand.

15. The apparatus of claim 13, wherein:
each data element in each second source vector operand is associated with a corresponding first dimension in the source matrix, wherein the corresponding first dimension comprises a corresponding row or a corresponding column in the source matrix; and
each data element in each second source vector operand provides a data value selected from among the data values in the corresponding first dimension in the source matrix.

16. The apparatus of claim 13, wherein the source matrix comprises a matrix with N:M structured sparsity, wherein each defined group of M data values in the source matrix comprises at most N non-zero data values.

17. The apparatus of claim 13, wherein the source matrix comprises a matrix of weights or a matrix of activations for use in execution of an artificial neural network.

18. A method comprising:
performing vector operations using processing circuitry;
decoding instructions from a set of instructions to control the processing circuitry to perform the vector operations specified by the instructions,
wherein:
the set of instructions comprises a multiple-outer-product instruction specifying a plurality of first source vector operands, at least one second source vector operand and correlation information associated with the at least one second source vector operand, wherein each vector operand comprises a plurality of data elements and, for a given second source vector operand, the correlation information is arranged to indicate, for each data element of the given second source vector operand, a corresponding first source vector operand;
the method comprises, in response to the multiple-outer-product instruction performing a plurality of computations to implement a plurality of outer product operations, wherein the plurality of outer product operations comprise, for a given first source vector operand, performing an associated outer product operation to calculate an outer product of the given first source vector operand with a subset of data elements of the at least one second source vector operand; and selecting, for each data element of the at least one second source vector operand, a corresponding first source vector operand to be used when performing the associated outer product operation, in dependence on the correlation information.

19. A computer program comprising instructions which, when executed on a computer, control the computer to provide:
processing program logic to perform vector operations; and
instruction decoder program logic to decode target instructions from a set of target instructions to control the processing program logic to perform the vector operations specified by the target instructions,
wherein:
the set of target instructions comprises a multiple-outer-product instruction specifying a plurality of first source vector operands, at least one second source vector operand and
correlation information associated with the at least one second source vector operand, wherein each vector operand comprises a plurality of data elements and, for a given second source vector operand, the correlation information is arranged to indicate, for each data element of the given second source vector operand, a corresponding first source vector operand;
the instruction decoder program logic is responsive to the multiple-outer-product instruction to control the processing program logic to perform a plurality of computations to implement a plurality of outer product operations, wherein the plurality of outer product operations comprise, for a given first source vector operand, performing an associated outer product operation to calculate an outer product of the given first source vector operand with a subset of data elements of the at least one second source vector operand; and
the processing program logic is configured to select, for each data element of the at least one second source vector operand, a corresponding first source vector operand to be used when performing the associated outer product operation, in dependence on the correlation information.

20. A computer-readable storage medium storing the computer program of claim 19.
